(19) United States
(12) Patent Application Publication
(10) Pub. No.: US 2024/0217181 A1
(43) Pub. Date: Jul. 4, 2024

(54) SYSTEMS AND METHODS FOR CONTROLLING ADDITIVE MANUFACTURING

(71) Applicant: Continuous Composites Inc., Coeur d'Alene, ID (US)

(72) Inventors: Jeffrey J. Wyrick, Dalton Gardens, ID (US); Chase Bosman, Post Falls, ID (US); Logan Lalonde, Post Falls, ID (US)

(73) Assignee: Continuous Composites Inc., Coeur d'Alene, ID (US)

(21) Appl. No.: 18/394,278

(22) Filed: Dec. 22, 2023

Related U.S. Application Data
(60) Provisional application No. 63/477,406, filed on Dec. 28, 2022.

(51) Int. Cl. B29C 64/393; B22F 10/85; B33Y 50/02

(52) U.S. Cl. CPC B29C 64/393; B22F 10/85; B33Y 50/02

(57) ABSTRACT

A method is disclosed for additively manufacturing a layer of a structure. The method may include determining a surface representing the layer of the structure, and determining a seed tool path lying on the surface. The method may further include, at each of a plurality of seed points along a length of the seed tool path, determining an offset direction that is transverse to an axis of the seed tool path at each of the plurality of seed points and parallel with the surface. The method may additionally include generating a plurality of offset points, each of which is offset in the offset direction from a corresponding one of the plurality of seed points. The method may also include determining an offset tool path based on the plurality of offset points, and causing a machine to discharge material along the offset tool path.

### RELATED APPLICATION

This application is based on and claims the benefit of priority from U.S. Provisional Application No. 63/477,406 that was filed on Dec. 28, 2022, the contents of which are expressly incorporated herein by reference.

### TECHNICAL FIELD

The present disclosure relates generally to additive manufacturing and, more specifically, to a method for determining tool paths useful in additive manufacturing. In some disclosed arrangements, the tool paths may be for manufacturing a three-dimensional layer of a structure using an additive manufacturing process.

### BACKGROUND

Traditional additive manufacturing is a process of creating three-dimensional parts by depositing overlapping layers of material under the guided control of a computer. A common form of additive manufacturing is known as fused deposition modeling (FDM). Using FDM, a thermoplastic is passed through and liquified within a heated print head. The print head is moved in a predefined trajectory (a.k.a., a tool path) as the material discharges from the print head, such that the material is laid down in a particular pattern and shape of overlapping two dimensional layers. The material, after exiting the print head, cools and hardens into a final form. A strength of the final form is primarily due to properties of the particular thermoplastic supplied to the print head and a three-dimensional shape formed by the stack of two-dimensional layers.

An improvement over traditional FDM manufacturing involves the use of continuous reinforcements embedded within material discharging from the print head. Such methods may be termed Continuous Reinforcement additive manufacturing. In exemplary continuous reinforcement additive manufacturing methods, a matrix can be supplied to the print head and discharged (e.g., extruded and/or pultruded) along with one or more continuous reinforcements also passing through the same print head at the same time. The matrix can be a traditional thermoplastic, a powdered metal, a liquid matrix (e.g., a UV curable and/or two-part resin), or a combination of any of these and other known matrixes. Upon exiting the print head, a cure enhancer (e.g., a UV light, a laser, an ultrasonic emitter, a temperature control source, a catalyst supply, etc.) is activated to initiate and/or complete curing (e.g., hardening, cross-linking, sintering, etc.) of the matrix. This curing, when completed quickly enough, can allow for unsupported structures to be fabricated in free space. And when reinforcements, particularly continuous reinforcements, are embedded within the structure, a strength of the structure may be multiplied beyond the matrix-dependent strength. An example of this technology is disclosed in U.S. Pat. No. 9,511,543 that issued to Tyler on Dec. 6, 2016.

Such methods permit the manufacture of complex elements without the use of supports and/or the manufacture of structural or loadbearing elements, which may form part of a product or apparatus.

The print head will deposit material along a predefined tool path when creating a three-dimensional part. Often, tool paths are arranged adjacent to each other such that they fuse during curing of the matrix. Accordingly, the position, trajectory, and alignment of the tool paths can have significant impact on properties of the three-dimensional parts being created. For example, the position, trajectory, and alignment may affect structural integrity, strength and load bearing capabilities of the part.

If the tool paths are not correctly positioned, projected, or aligned, adjacent tows may not fuse as desired. This can result in unwanted gaps between tows and/or unwanted overlapping of tows, as well as other potential problems. When a layer of a part to be deposited by the print head is planar, alignment of adjacent tool paths can be accurately determined. However, when the layer of the part is non-planar and is represented by a three-dimensional or non-planar surface, alignment and relative position of tool paths is more challenging to determine accurately.

The disclosed systems and methods address one or more of the above-mentioned issues and/or other issues in the prior art.

### SUMMARY

Applicants have appreciated there is a need for methods, apparatuses, and systems that can accurately determine the position and/or alignment of tool paths on planar surfaces and/or non-planar three-dimensional surfaces for an additive manufacturing process. The methods and apparatus disclosed herein may provide for greater accuracy, less computational intensity and/or greater efficiency when determining tool paths of a layer of a part.

Aspects and optional features of the methods, apparatuses, and systems disclosed herein are provided below. It is noted that the claims may show restricted dependency of optional features, but this should not limit the scope of this disclosure. Optional features of the methods and apparatus mentioned herein may be combined in any number of ways, as would be understood by a skilled person.

In an aspect, there is provided a method of additively manufacturing a layer of a structure. The method may include determining a surface representing the layer of the structure, and determining a seed tool path lying on the surface. The method may further include, at each of a plurality of seed points along a length of the seed tool path, determining an offset direction that is transverse to an axis of the seed tool path at each of the plurality of seed points and parallel with the surface. The method may additionally include generating a plurality of offset points, each of which is offset in the offset direction from a corresponding one of the plurality of seed points. The method may also include determining an offset tool path based on the plurality of offset points, and causing a machine to discharge material along the offset tool path.

In another aspect, there is provided a computer program product comprising computer program code that, when executed on a computer processor, is configured to a method of additively manufacturing a layer of a structure. The method may include determining a surface representing the layer of the structure, and determining a seed tool path lying on the surface. The method may further include, at each of a plurality of seed points along a length of the seed tool path, determining an offset direction that is transverse to an axis of the seed tool path at each of the plurality of seed points and parallel with the surface. The method may additionally include generating a plurality of offset points, each of which is offset in the offset direction from a corresponding one of the plurality of seed points. The method may also include determining an offset tool path based on the plurality of offset points, and causing a machine to discharge material along the offset tool path.

### BRIEF DESCRIPTION OF THE DRAWINGS

FIG. 1 is a diagrammatic illustration of an exemplary additive manufacturing machine and a corresponding control system that may be used to control the machine;

FIG. 2 is a schematic illustration of the control system of FIG. 1;

FIG. 3 is a flow diagram showing a method of determining a tool path for use in an additive manufacturing process for manufacturing a three-dimensional layer of a structure;

FIG. 4 is a schematic representation of a structure showing a layer and a seed tool path;

FIG. 5 is a schematic representation showing a plan view of a seed tool path and an offset tool path on a surface; and

FIG. 6 is a schematic representation showing a perspective view of a seed tool path and an offset tool path on a surface.

### DETAILED DESCRIPTION

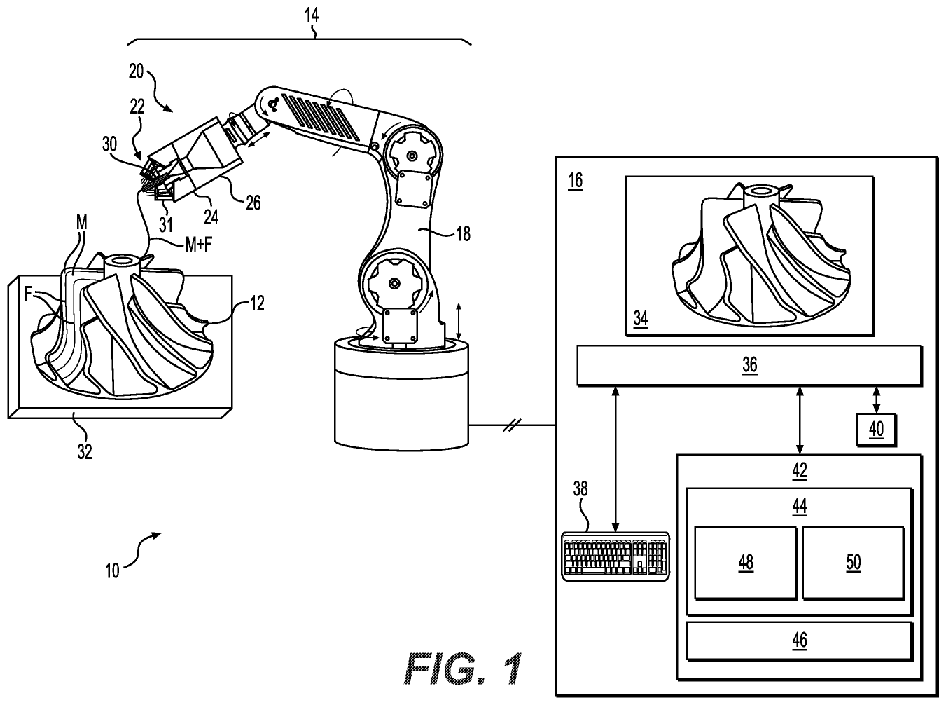

FIG. 1 illustrates an exemplary control system (“system”) 10, which may be used to design, plan, fabricate, and/or analyze a structure 12 having any desired shape, size, consist, and functionality. System 10 may include, among other things, an additive manufacturing machine (“machine”) 14 and at least one computing device 16 operatively connected to machine 14. Machine 14 may be configured to create structure 12 under the guided control of computing device 16, for example by way of an additive manufacturing process. Although additive manufacturing processes utilizing one or more continuous reinforcements (e.g., fibers—shown as F in FIG. 1) and one or more curable matrixes (shown as M in FIG. 1) will be described below as examples of how structure 12 (or other structures) may be created, it should be noted that other processes known in the art could alternatively be utilized for this purpose and benefit from the disclosed control systems and methods.

Each head 20 (only one shown in FIG. 1, for clarity) may be configured to discharge at least a matrix (e.g., a liquid resin, such as a zero volatile organic compound resin; a powdered metal; etc.) that is curable. Exemplary curable matrixes include a thermoset polymer, single- or multi-part epoxy resins, polyester resins, cationic epoxies, acrylated epoxies, urethanes, esters, a thermoplastic polymer, photopolymers, polyepoxides, thiols, alkenes, thiol-enes, and more. In one embodiment, the matrix inside each head 20 may be pressurized, for example by an external device (e.g., an extruder or another type of pump—not shown) that is fluidly connected to head 20 via a corresponding conduit (not shown). In another embodiment, the pressure may be generated completely inside of head 20 by a similar type of device. In yet other embodiments, the matrix may be gravity-fed through and/or mixed within head 20. In some instances, the matrix inside head 20 may need to be kept cool and/or dark to inhibit premature curing; while in other instances, the matrix may need to be kept warm and/or light for the same reason. In either situation, head 20 may be specially configured (e.g., insulated, temperature controlled, shielded, etc.) to provide for these needs.

In some embodiments, the matrix may be mixed with, contain, or otherwise at least partially wet or coat one or more reinforcements (e.g., fibers). Fibers may be individual fibers, braids, tows, rovings, sleeves, ribbons, and/or sheets of material and, together with the matrix, make up at least a portion (e.g., a wall) of structure 12. The reinforcement may be stored within (e.g., on one or more separate internal spools—not shown) or otherwise passed through head 20 (e.g., fed from one or more external spools). When multiple fibers are simultaneously used as the reinforcement, the fibers may be of the same type and have the same diameter, cross-sectional shape (e.g., circular, rectangular, triangular, etc.), and sizing, or of a different type with different diameters, cross-sectional shapes, and/or sizing. The reinforcement may include, for example, aramid fibers, carbon fibers, vegetable fibers, wood fibers, mineral fibers, glass fibers, metallic wires, optical tubes, etc. It should be noted that the term “reinforcement” is meant to encompass both structural and non-structural (e.g., functional) types of continuous reinforcements that can be at least partially encased in the matrix discharging from head 20. The matrix/reinforcement can be considered to be continuous in so far as the reinforcement discharging from machine 14 are from a continuous length provided together with matrix M, and which may be cut by machine 14 at desired lengths based on the design of structure 12. It will be appreciated that, while some or all the reinforcement may be used principally for structural purposes, it may additionally or alternatively be used for other purposes (e.g., communication purposes).

The reinforcement may be exposed to (e.g., at least partially wetted, coated with, and/or fully saturated in) the matrix while inside head 20, while being passed to head 20, and/or while discharging from head 20, as desired. The matrix, dry fibers, and/or fibers that are already exposed to the matrix (e.g., wetted fibers) may be transported into head 20 in any manner apparent to one skilled in the art.

Support 18 may move head 20 in a particular trajectory (e.g., a trajectory corresponding to an intended shape, size, and/or function of structure 12) at the same time that the matrix-wetted reinforcement discharges from head 20, such that one or more continuous paths of matrix-wetted reinforcement are formed along the trajectory. Each path may have any cross-sectional shape, diameter, and/or reinforcement-to-matrix ratio, and the reinforcement may be radially dispersed with the matrix, located at a general center thereof, or located only at a periphery.

One or more cure enhancers (e.g., a UV light, a laser, an ultrasonic emitter, a temperature regulator, a catalyst dispenser, etc.) 22 may be mounted proximate (e.g., within, on, and/or adjacent) head 20 and configured to enhance a cure rate and/or quality of the matrix as it is discharged from head 20. Cure enhancer(s) 22 may be regulated to selectively expose surfaces of structure 12 to a desired type, intensity, and/or dosage of energy (e.g., to UV light, electromagnetic radiation, vibrations, heat, a chemical catalyst or hardener, etc.) during the formation of structure 12. The energy may trigger a cross-linking chemical reaction within the matrix, increase a rate of chemical reaction occurring within the matrix, sinter the matrix, harden the matrix, or otherwise cause the matrix to cure as it discharges from head 20. In the depicted embodiments, cure enhancer(s) 22 include multiple LEDs that are equally distributed about a center axis of head 20. However, it is contemplated that any number of LEDs and/or other energy sources could alternatively be utilized for the disclosed purposes and/or arranged in another manner (e.g., unequally distributed, arranged in a row, only leading, only trailing, etc.). For example, cure enhancers 22 could be located on an arm (not shown) that trails behind head 20 and/or on a portion of support 18, if desired. The amount of energy produced by cure enhancer(s) 22 and absorbed by the matrix may be sufficient to at least partially cure an exposed surface of the matrix before structure 12 axially grows more than a predetermined length away from head 20. In one embodiment, structure 12 is mostly or completely cured before the axial growth length becomes equal to an external diameter of the matrix-coated reinforcement.

In the embodiment of FIG. 1, head 20 is modular. For example, head 20 may include a matrix reservoir 26 and an outlet 24 that is removably connected to matrix reservoir 26 (e.g., via one or more threaded fasteners, clasps, actuators, and/or other hardware—not shown). In this example, outlet 24 is a single-track outlet configured to discharge composite material having a generally circular, rectangular, triangular, and/or other polygonal cross-section. The configuration of head 20, however, may allow outlet 24 to be swapped out for another outlet that discharges composite material having a different shape (e.g., a tubular cross-section, a ribbon or sheet cross-section, etc.) and/or a different number of tracks. It is also contemplated that head 20 may itself be selectively swapped out for a differently configured head, if desired.

In some embodiments, cure enhancer(s) 22 may be mounted to a lower portion (e.g., a portion distal from matrix reservoir 26) of outlet 24. With this configuration, cure enhancer(s) 22 may be located at or around a distal end in a configuration that best suits the shape, size, and/or type of material discharging from outlet 24. In the disclosed embodiment, cure enhancer(s) 22 are mounted at an angle relative to a central axis of outlet 24, such that energy from cure enhancer(s) 22 is directed centrally toward the material discharging from outlet 24.

One or more optics 31 may be used in some applications to selectively block, disperse, focus, and/or aim the energy from cure enhancer(s) 22 at an opening of outlet 24. This may affect a cure rate of and/or cure location on the material discharging from outlet 24. It is contemplated that optics 31 may be adjustable, if desired (e.g., manually adjustable via a set screw—not shown, or automatically adjustable via an actuator—not shown).

The matrix and/or reinforcement may be discharged together from head 20 via any number of different modes of operation. In a first example mode of operation, the matrix and/or reinforcement are extruded (e.g., pushed under pressure and/or mechanical force) from head 20 as head 20 is moved by support 18 to create features of structure 12. In a second example mode of operation, at least the reinforcement is pulled from head 20, such that a tensile stress is created in the reinforcement during discharge. In this second mode of operation, the matrix may cling to the reinforcement and thereby also be pulled from head 20 along with the reinforcement, and/or the matrix may be discharged from head 20 under pressure along with the pulled reinforcement. In the second mode of operation, where the reinforcement is being pulled from head 20, the resulting tension in the reinforcement may increase a strength of structure 12 (e.g., by aligning the reinforcement, inhibiting buckling, equally loading the reinforcement, etc.) after curing of the matrix, while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 20 as a result of head 20 being moved and/or tilted by support 18 away from an anchor point 32 (e.g., a print bed, an existing surface of structure 12, a fixture, etc.). For example, at the start of structure formation, a length of matrix-impregnated reinforcement may be pulled and/or pushed from head 20, deposited against anchor point 32, and at least partially cured, such that the discharged material adheres (or is otherwise coupled) to anchor point 32. Thereafter, head 20 may be moved and/or tilted away from anchor point 32, and the relative motion may cause the reinforcement to be pulled from head 20. The movement of reinforcement through head 20 may be selectively assisted via one or more internal feed mechanisms, if desired. However, the discharge rate of reinforcement from head 20 may primarily be the result of relative movement between head 20 and anchor point 32, such that tension is created within the reinforcement. Anchor point 32 could be moved away from head 20 instead of or in addition to head 20 being moved away from anchor point 32.

Any number of separate computing devices 16 may be used to design and/or control the placement of fibers within structure 12 and/or to analyze performance characteristics of structure 12 before, during, and/or after formation. Computing device 16 may include, among other things, a display 34, one or more processors 36, any number of input/output (“I/O”) devices 38, any number of peripherals 40, and one or more memories 42 for storing programs 44 and data 46. Programs 44 may include, for example, any number of design and/or printing apps 48 and an operating system 50.

Display 34 of computing device 16 may include a liquid crystal display (LCD), a light emitting diode (LED) screen, an organic light emitting diode (OLED) screen, and/or another known display device. Display 34 may be used for presentation of data under the control of processor 36.

Processor 36 may be a single or multi-core processor configured with virtual processing technologies and use logic to simultaneously execute and control any number of operations. Processor 36 may be configured to implement virtual-machine or other known technologies to execute, control, run, manipulate, and store any number of software modules, applications, programs, etc. In addition, in some embodiments, processor 36 may include one or more specialized hardware, software, and/or firmware modules (not shown) specially configured with particular circuitry, instructions, algorithms, and/or data to perform functions of the disclosed methods. It is appreciated that other types of processor arrangements could be implemented that provide for the capabilities disclosed herein.

Memory 42 can be a volatile or non-volatile, magnetic, semiconductor, tape, optical, removable, non-removable, or other type of storage device or tangible and/or non-transitory computer-readable medium that stores one or more executable programs 44, such as analysis and/or printing apps 48 and operating system 50. Common forms of non-transitory media include, for example, a flash drive, a flexible disk, a hard disk, a solid state drive, magnetic tape or other magnetic data storage medium, a CD-ROM or other optical data storage medium, any physical medium with patterns of holes, a RAM, a PROM, an EPROM, a FLASH-EPROM or other flash memory, NVRAM, a cache, a register or other memory chip or cartridge, and networked versions of the same.

Memory 42 may store instructions that enable processor 36 to execute one or more applications, such as design and/or fabrication apps 48, operating system 50, and any other type of application or software known to be available on computer systems. Alternatively or additionally, the instructions, application programs, etc. can be stored in an internal and/or external database (e.g., a cloud storage system—not shown) that is in direct communication with computing device 16, such as one or more databases or memories accessible via one or more networks (not shown). Memory 42 can include one or more memory devices that store data and instructions used to perform one or more features of the disclosed embodiments. Memory 42 can also include any combination of one or more databases controlled by memory controller devices (e.g., servers, etc.) or software, such as document management systems, Microsoft SQL databases, SharePoint databases, Oracle™ databases, Sybase™ databases, or other relational databases.

In some embodiments, computing device 16 is communicatively connected to one or more remote memory devices (e.g., remote databases—not shown) through a network (not shown). The remote memory devices can be configured to store information that computing device 16 can access and/or manage. By way of example, the remote memory devices could be document management systems, Microsoft SQL database, SharePoint databases, Oracle databases, Sybase databases, Cassandra, HBase, or other relational or non-relational databases or regular files. Systems and methods consistent with disclosed embodiments, however, are not limited to separate databases or even to the use of a database.

Programs 44 may include one or more software or firmware modules causing processor 36 to perform one or more functions of the disclosed embodiments. Moreover, processor 36 can execute one or more programs located remotely from computing device 16. For example, computing device 16 can access one or more remote programs that, when executed, perform functions related to disclosed embodiments. In some embodiments, programs 44 stored in memory 42 and executed by processor 36 can include one or more of design, fabrication, and/or analysis apps 48 and operating system 50. Apps 48 may cause processor 36 to perform one or more functions of the disclosed methods.

Operating system 50 may perform known operating system functions when executed by one or more processors such as processor 36. By way of example, operating system 50 may include Microsoft Windows, Unix, Linux, OSX, IOS, Raspberry Pi OS (e.g., Rapbian), Android, or another type of operating system 50. Accordingly, disclosed embodiments can operate and function with computer systems running any type of operating system 50.

I/O devices 38 may include one or more interfaces for receiving signals or input from a user and/or machine 14, and for providing signals or output to machine 14 that allow structure 12 to be printed. For example, computing device 16 can include interface components for interfacing with one or more input devices, such as one or more keyboards, mouse devices, and the like, which enable computing device 16 to receive input from a user.

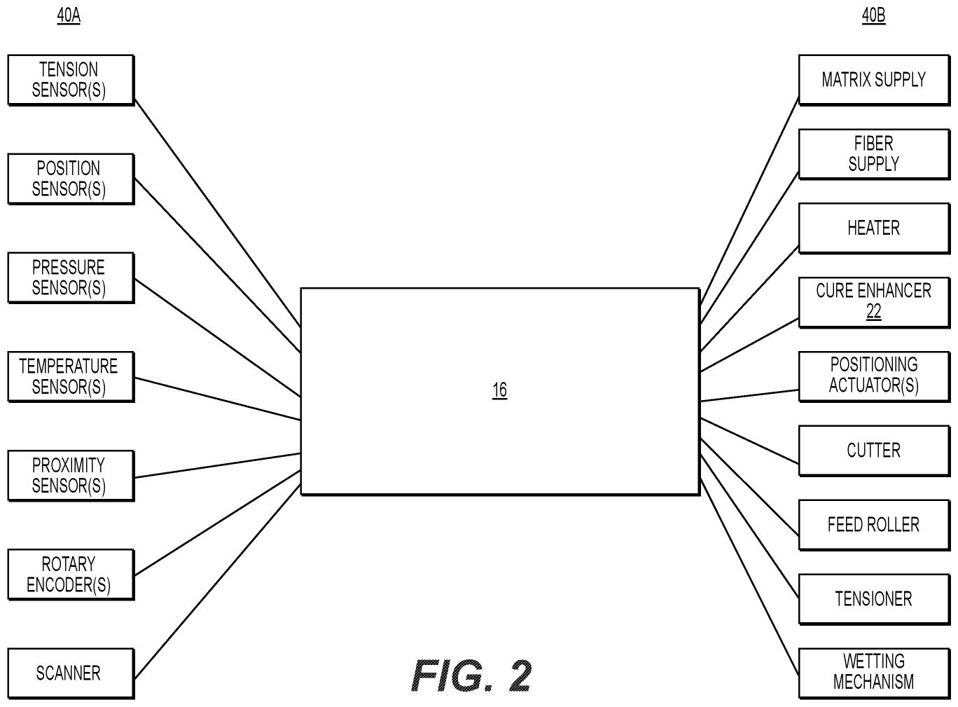

Peripheral device(s) 40 may be standalone devices or devices that are embedded within or otherwise associated with machine 14 and used during fabrication of structure 12. As shown in FIG. 2, peripherals 40 can embody input devices (e.g., one or more sensors, such as tension sensors, position sensors, pressure sensors, temperature sensors, proximity sensors, level sensors, rotary encoders, scanners, potentiometers, and other sensors known in the art) 40A and/or output devices (e.g., one or more actuators, such as a matrix supply, a fiber supply, a heater, a pump, cure enhancer 22, a positioning motor, a cutter, a feed roller, a tensioner, a wetting mechanism, a compactor, etc.) 40B. In some embodiments, peripheral device(s) 40 may, themselves, include one or more processors (e.g., a programmable logic control (PLC), a computer numeric controller (CNC), etc.), a memory, and/or a transceiver. When peripheral device(s) 40 are equipped with a dedicated processor and memory, the dedicated processor may be configured to execute instructions stored on the memory to receive commands from processor 36 associated with video, audio, other sensory data, control data, location data, etc., including capture commands, processing commands, motion commands, and/or transmission commands. The transceiver may include a wired or wireless communication device capable of transmitting data to or from one or more other components in system 10. In some embodiments, the transceiver can receive data from processor 36, including instructions for sensor and/or actuator activation and for the transmission of data via the transceiver. In response to the received instructions, the transceiver can packetize and transmit data between processor 36 and the other components.

Design, fabrication, and/or analysis apps 48 may cause computing device 16 to perform methods related to generating, receiving, processing, analyzing, storing, and/or transmitting data in association with operation of machine 14 and corresponding design/fabrication/analysis of structure 12. For example, apps 48 may be able to configure computing device 16 to perform operations including: displaying a graphical user interface (GUI) on display 34 for receiving design/control instructions and information from the operator of machine 14; capturing sensory data associated with machine 14 (e.g., via peripherals 40A); receiving instructions via I/O devices 38 and/or the user interface regarding specifications, desired characteristics, and/or desired performance of structure 12; processing the control instructions; generating one or more possible designs of and/or plans for fabricating structure 12; analyzing and/or optimizing the designs and/or plans; providing recommendations of one or more designs and/or plans; controlling machine 14 to fabricate a recommended and/or selected design via a recommended and/or selected plan; analyzing the fabrication; and/or providing feedback and adjustments to machine 14 for improving future fabrications.

The disclosed systems may be used to continuously manufacture composite structures having any desired cross-sectional shape, length, density, stiffness, strength, and/or other characteristic. The composite structures may be fabricated from any number of different reinforcements of the same or different types, diameters, shapes, configurations, and consists, and/or any number of different matrixes.

When designing three-dimensional structures 12 to be manufactured by the (or another) additive manufacturing machine 14, a virtual model of structure 12 may be split into a number of layers. The layers may be determined such that they may be deposited adjacent to each other (e.g., one on top of the other) to build up structure 12 from the print bed. In other arrangements, the layers may be configured to be manufactured in free space. One or more tool paths are then determined that govern where head 20 deposits material within each layer.

If a layer in the virtual model is two-dimensional (planar), the position and alignment of tool paths may be determined by offsetting from a seed tool path within the plane of the layer. If such an offset tool path is to be immediately adjacent to the seed tool path, then a magnitude of the offset may be substantially equal to (or less than) the width of the material to be deposited. In this way, the matrix of the material will, when cured, fuse to the material previously deposited along the seed tool path. For subsequent offset tool paths, the previously offset tool path may become the seed tool path. In some arrangements, the original seed tool path may be used as the seed tool path for generating all subsequent offset tool paths. It is noted that, in some arrangements, at least part of two adjacent tool paths may be separated and not be touching, for example to accommodate different intersection designs. This is discussed in US patent publications 20220266525, 20220266526, 20220266527, and 20220317657 filed in 23 Feb. 2022, the contents of which are incorporated by reference.

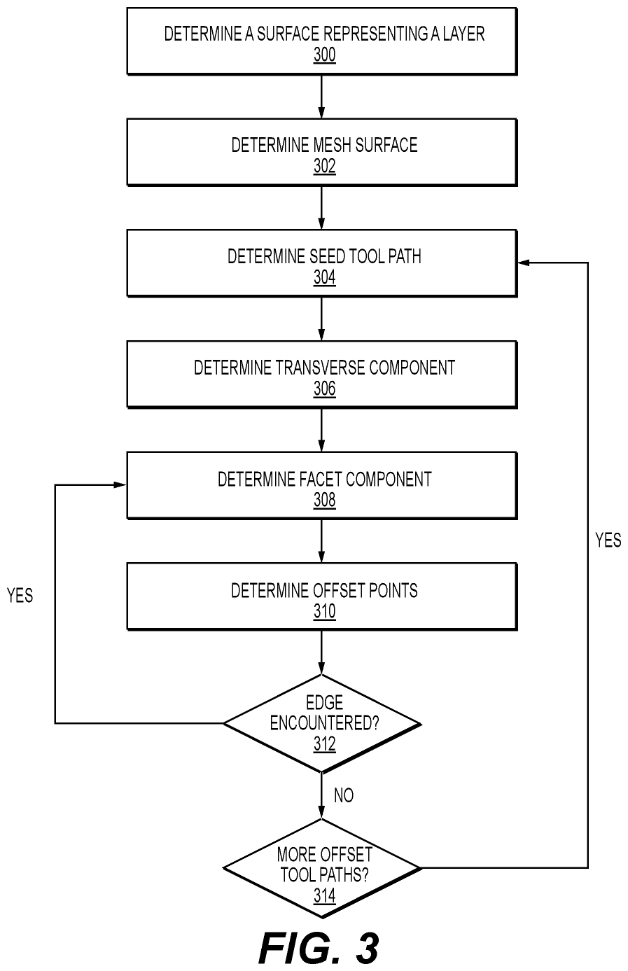

FIGS. 3-6 illustrate methods of the disclosed embodiments that may be implemented by system 10. FIGS. 3-6 will be described in more detail below to further illustrate these embodiments.

### INDUSTRIAL APPLICABILITY

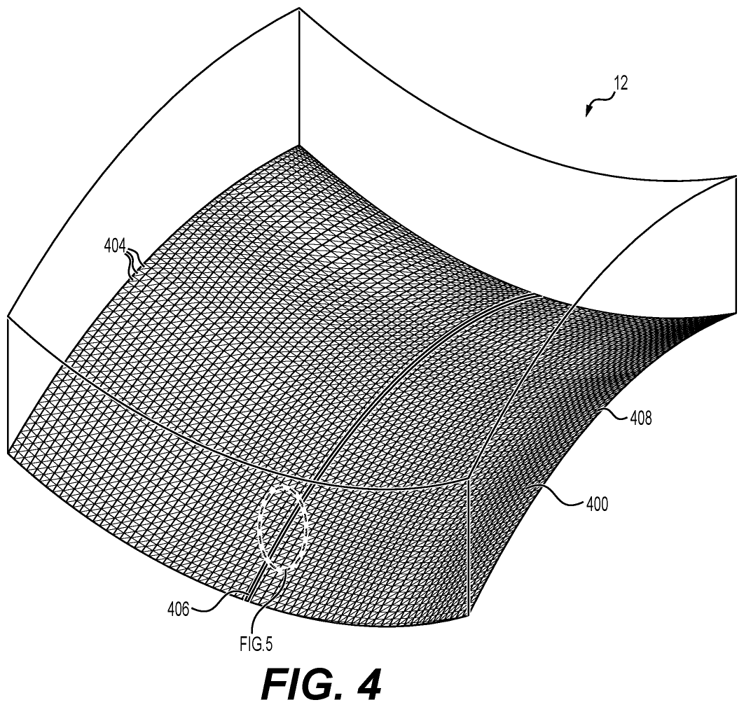

FIG. 3 shows a flow diagram of a method for determining a tool path that can be used by system 10 in an additive manufacturing process. The method may be implemented, in whole or in part, by computing device 16. Alternatively, the method may be implemented, in whole or in part, by a separate device that is configured to upload relevant information to computing device 16. The additive manufacturing process may be beneficial for determining tool paths for a three-dimensional (e.g., non-planar) layer in a virtual model of structure 12. The method disclosed in FIG. 3 is described below with reference to FIGS. 4-6.

A virtual model of structure 12 is shown in FIG. 4 as having a selectable surface 400. Surface 400 may represent a layer of structure 12 to be manufactured and coincide with any suitable reference. For example, surface 400 may be selected by the user of system 10 to coincide with a bottom surface of the virtual model, a top surface of the virtual model, or a surface part-way through a thickness or depth of the virtual model. In the exemplary arrangement discussed below, surface 400 is considered to be coincident with the bottom surface of the virtual model. As shown in FIG. 4, surface 400 has a saddle, or hyperbolic paraboloid, shape. This shape is only exemplary and used for explanation of the methods and apparatus disclosed herein. It should not be considered limiting.

Surface 400 may be meshed (step 302) before or after user selection at step 300. This may be done using any known techniques. The mesh of surface 400 may be represented as a plurality of mesh elements or polygons 404. Polygons 404 may be adjacent to each other and connected along common edges. Each polygon 404 of the mesh may be planar and form a single facet of surface 400. An angle between adjacent facets of polygons 404 may at least partially define the non-planar shape of surface 400 in a discrete way that is more easily handled by computing device 16. Polygons 404 used in the example mesh of surface 400 are triangles. However, other shapes of polygons and/or combinations of shapes may also be used.

A seed tool path 406 may be determined (step 304) in a number of ways. In exemplary arrangements, seed tool 406 path may be formed as an edge or boundary 408 of surface 400. Alternatively, as shown in FIG. 4, seed tool path 406 may be determined to be lying on surface 402 within boundary 408 of the surface.

In some exemplary arrangements, seed tool path 408 may be determined by mapping the three-dimensional mesh surface 400 to two-dimensional space, selecting an appropriate seed tool path 406 in two-dimensional space, and then mapping seed tool path 406 back to the three-dimensional space. Many options exist for such mapping functions. In some arrangements, a mapping function may be chosen that preserves shape over angle, thereby retaining the relative position of points on mesh surface 400 as much as possible when the mapping from three dimensions to two dimensions and vice-versa. For example, a mesh parameterization function, such as a UV parameterization function may be used.

In exemplary arrangements, seed tool path 406 may be manually selected and/or generated by a user. In other arrangements, a graph structure (e.g., including a plurality of nodes and edges) of the layer may be determined and one or more features of the structure may form at least a part of seed tool path 406. For example, the layer may include a plurality of elongate members that are connected at a plurality of junctions. In such arrangements, a node may be located at one or more of the junctions, and edges of polygons 404 may connect the nodes. The edges may run down a general center or centerline of each elongate member. One or more of such edges may form at least part of seed tool path 406. This is discussed in US patent publications 20220266525, 20220266526, 20220266527, and 20220317657 filed in 23 Feb. 2022, the contents of which, as already mentioned above, are incorporated by reference.

It will be appreciated that seed tool path 406 may run parallel or transverse (e.g., perpendicular) to a boundary 408 of mesh surface 402. It will also be appreciated that seed tool path 406 may take a linear or curved path over the mesh surface (e.g., regardless of whether the boundary is linear or curved).

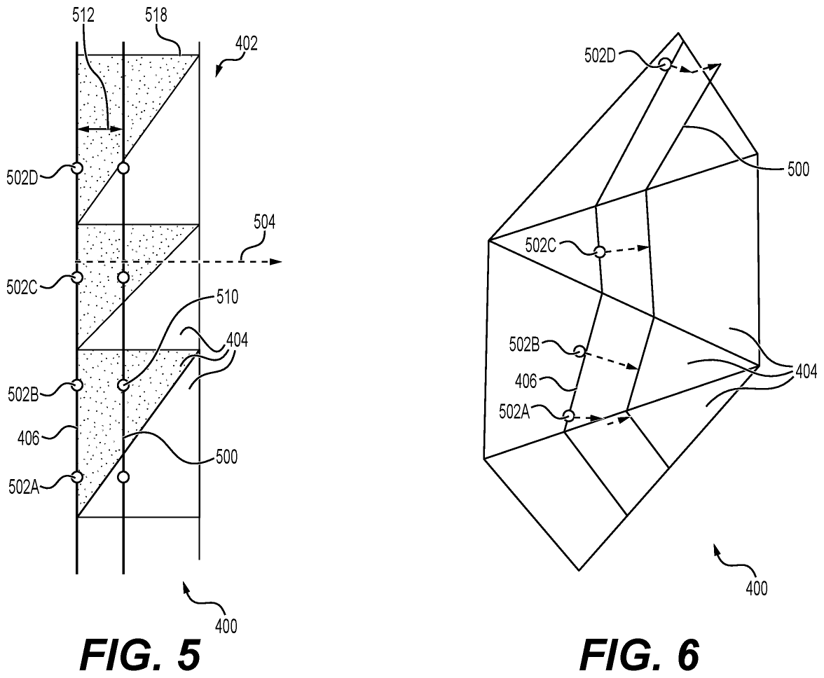

Seed tool path 406 may be a discrete representation of a straight or curved line extending across mesh surface 402. While appearing as a single continuous straight or smoothly curving path in the two-dimensional space (e.g., see FIG. 5), where all of the mesh elements (i.e., polygons 404) lie within a common plane, seed tool path 406 may in fact comprise a plurality of aligned or misaligned segments that are joined end-to-end. This may be more apparent in the three-dimensional space (e.g., see FIG. 6), where the continuity between segments may not appear as smooth. Each segment of seed tool path 406 may extend along a border or across a face (e.g., between opposing borders) of each mesh element. Multiple sequential segments of seed tool path 406 may, for example, pass along edges of a number of polygons 404 when boundary 408 of mesh surface 402 is selected as seed tool path 406. However, this need not always be the case, and seed tool path 406 may pass over the faces of one or more of polygons 404. This helps to align the resolution of mesh surface 402 and the resolution of seed tool path 406. It should be noted that seed path 406 could alternatively be selected/designated within the three-dimensional space (i.e., without any mapping), if desired

A plurality of seed points 502A-D may be selected along seed tool path 406 for use in generating an offset tool path 500 adjacent seed tool path 406, as shown in FIG. 5. The number of seed points 502A-D on seed tool path 406 may be selected such that at least one seed point 502A-D is present on the face or on an edge of each of polygons 404 that seed tool path 406 touches. In other arrangements, a spacing between seed points 502A-D may be determined based on a dimension of polygons 404, and optionally based on an average dimension of a plurality of polygons 404. For example, an average length of a plurality of polygons 404 may be determined and a spacing between seed point 502A-D may be determined to have a corresponding length, which may, for example, be less than or equal to the average length of polygons 404. This may result in a seed point 502A-D being present on the face or on an edge of a majority of polygons 404. In exemplary arrangements, seed points 502A-D may coincide with segment ends of seed tool path 406. In other arrangements, additional and/or different seed points 502A-D on seed tool path 406 may be selected.

An offset direction 504 may be determined at each seed point 502A-D of seed tool path 406. The offset direction may be determined to be transverse (e.g., perpendicular) to an axis of seed tool path 406 at each seed point 502A-D and parallel with (e.g., lying on) a face of a first polygon 404 of mesh surface 402 that is encountered in offset direction 504. In exemplary arrangements, the axis may comprise a line that is tangential to an arc forming at least part of seed tool path 406.

Processor 36 may determine the location of a plurality of offset points 510 (step 310) that are each an offset distance 512 away from a corresponding seed point (e.g., 502C) in offset direction 504. In exemplary arrangements, offset distance 512 may be the width of a tow to be deposited by print head 20. When all offset points 510 are determined, offset tool path 500 may be determined that passes sequentially through each of the plurality of offset points 510. In some arrangements, offset tool path 500 may be generated by connecting adjacent offset points 510 with straight line segments, although other algorithms may be used that would fit a straight or curved line generally through offset points 510.

In exemplary arrangements, a plurality of offset directions 504 may be determined. For example, a first offset direction may be determined as described above, and a second offset direction may be determined in the same or a similar way but on an opposite side of seed tool path 406. The first and second offset directions may be opposite to each other. Accordingly, the locations of two sets of offset points 510 and two offset paths 500 may be determined simultaneously, one on each side of seed tool path 406. In such arrangements, offset tool paths 500 in each direction may continue to be determined until all offset points 510 for that particular offset tool path 500 fall outside of a virtual boundary of structure 12.

It may be possible, in some applications, for offset distance 512 to be large enough to push an offset point from the face or edge of one mesh element (e.g., a first of polygons 404) onto an adjacent mesh element (e.g., see points 502A and 502D in FIG. 5). In this case, offset direction 504 remains the same despite an edge the first polygon 404 being encountered or crossed, because the mesh elements shown in FIG. 5 lie within a common plane. In other examples, however, if an edge of a polygon 404 is encountered or crossed (step 312) before the full offset distance 512 is reached, an updated offset direction 504 may be determined that initiates from the edge of the polygon 404. In this situation, it may be possible for the face of first polygon 404 to be at an angle to the face of the newly encountered polygon 404 (i.e., to not lie within the same plane—see FIG. 6). When this occurs, the transverse offset direction from the first polygon 404 may be projected onto the face of the newly encountered polygon 404. That is, from an edge of the original polygon 404, the offset direction may change and continue transversely away from seed tool path 406 already determined; but the new offset being parallel to the face of the newly encountered polygon 404. Offset distance 512 may then be split between the distance extended on the face of the first polygon 404 and the distance extended onto the face of the newly encountered polygon 404. It is noted that this process may be repeated if multiple additional polygons 404 are encountered in offset direction 504 before offset distance 512 has been fully travelled. The offset may traverse as many polygons 404 as necessary to travel the complete offset distance 512 from the corresponding seed toolpath point 502A-D.

Once all of the different tool paths necessary to complete a given layer of structure 12 have been generated by completing Steps 304-312 (i.e., once all offset points have been offset past an outer boundary of structure 12), the different tool paths may be used to regulate operation of machine 12. That is, the tool paths may be converted into code that regulates operation of head 16 and support 18, causing machine 14 to deposit material (e.g., matrix and reinforcement) along each of the paths.

The disclosed systems and methods may be used to correctly position, project, and/or align adjacent tows such that they fuse together within a given layer and between layers. This may reduce or eliminate unwanted gaps between tows and/or unwanted overlapping of tows, as well as other potential problems. By improving fusion and eliminating gaps and/or overlaps, structure 12 may have improved properties (e.g., strength, rigidity, density, etc.). The disclosed systems and methods may be particularly beneficial when a layer of structure 12 is non-planar and alignment and relative positioning of adjacent tool paths is more challenging to determine accurately.

It will be apparent to those skilled in the art that various modifications and variations can be made to the disclosed systems and methods. Other embodiments will be apparent to those skilled in the art from consideration of the specification and practice of the disclosed systems and methods. It is intended that the specification and examples be considered as exemplary only, with a true scope being indicated by the following claims and their equivalents.

What is claimed is:

1. A method of additively manufacturing a layer of a structure, the method comprising:
determining a surface representing the layer of the structure;
determining a seed tool path lying on the surface;
at each of a plurality of seed points along a length of the seed tool path, determining an offset direction that is transverse to an axis of the seed tool path at each of the plurality of seed points and parallel with the surface;
generating a plurality of offset points, each of which is offset in the offset direction from a corresponding one of the plurality of seed points;
determining an offset tool path based on the plurality of offset points; and
causing a machine to discharge material along the offset tool path.

2. The method of claim 1, wherein the offset direction is perpendicular to the axis of the seed tool path at each of the plurality of seed points.

3. The method of claim 1, wherein the axis comprises a line tangential to an arc forming at least part of the seed tool path.

4. The method of claim 1, wherein determining the seed tool path includes:
applying a mapping function to the surface to transform the surface from a three-dimensional surface to a two-dimensional surface;
determining a two-dimensional seed tool path on the two-dimensional surface; and
applying a mapping function to the two-dimensional seed tool path to generate a three-dimensional seed tool path.

5. The method of claim 1, wherein determining the offset tool path based on the plurality of offset points includes connecting the plurality of offset points with straight edges.

6. The method of claim 1, further including:
determining a second seed tool path based on the offset tool path;
at each of a plurality of second seed points along a length of the second seed tool path, determining a second offset direction that is transverse to a second axis of the second seed tool path and parallel with the surface;
generating a plurality of second offset points, each of which is offset in the second offset direction from a corresponding one of the plurality of second seed points;
determining a second offset tool path based on the plurality of second offset points; and
causing the machine to deposit material along the second offset tool path.

7. The method of claim 1, further including:
generating a plurality of second offset points, each of which is offset in the offset direction from a corresponding one of the plurality of seed points;
determining a second offset tool path based on the plurality of second offset points; and
causing the machine to deposit material along the second offset tool path.

8. The method of claim 1, further including:
at each of the plurality of seed points along a length of the seed tool path, determining a second offset direction opposite the offset direction and parallel with the surface;
generating a plurality of second offset points, each of which is offset in the second offset direction from a corresponding one of the plurality of seed points;
determining a second offset tool path based on the plurality of second offset points; and
causing the machine to deposit material along the second offset tool path.

9. The method of claim 1, wherein the offset tool path is determined to pass sequentially through each of the plurality of offset points.

10. The method of claim 1, wherein determining the surface includes determining a mesh that comprises a plurality of adjacent polygons.

11. The method of claim 10, wherein:
the surface is a three-dimensional surface; and
determining the offset direction includes determining a linear direction that is parallel with a face of a first polygon of the mesh in the offset direction.

12. The method of claim 11, further including:
making a determination that a distance from the corresponding one of the plurality of seed points to an edge of the first polygon in the offset direction is less than an offset distance between the offset tool path and the seed tool path; and
selectively updating the offset direction based on the determination, such that the offset direction is transverse to the axis of the seed tool path at the corresponding one of the plurality of seed points and parallel with a second polygon of the mesh that is adjacent to the first polygon.

13. The method of claim 12, further including offsetting at least one of the plurality of offset points from the corresponding one of the plurality of seed points a remainder of the offset distance in the updated offset direction.

14. The method of claim 10, wherein the plurality of seed points are determined such that at least one of the plurality of seed points lies within or on an edge of each polygon that the seed tool path touches.

15. The method of claim 10, wherein a spacing between the plurality of seed points is determined based on a dimension of polygons that the seed tool path touches.

16. The method of claim 15, wherein the spacing between the plurality of seed points is determined based on an average length of the polygons that the seed tool path touches.

17. The method of claim 16, wherein the spacing between the plurality of seed points is less than or equal to the average length.

18. The method of claim 10, wherein the seed tool path includes a plurality of segments connected end-to-end.

19. The method of claim 18, wherein each of the plurality of seed points is positioned at an end of a segment of the seed tool path.

20. A computer program product comprising computer program code that, when executed on a computer processor, is configured to undertake method steps of:
determining a surface representing a layer of a structure;
determining a seed tool path lying on the surface;
at each of a plurality of seed points along a length of the seed tool path, determining an offset direction that is transverse to an axis of the seed tool path at each of the plurality of seed points and parallel with the surface;
generating a plurality of offset points, each of which is offset in the offset direction from a corresponding one of the plurality of seed points;
determining an offset tool path based on the plurality of offset points; and
causing a machine to deposit material along the offset tool path.
